(19) United States
(12) Patent Application Publication
(10) Pub. No.: US 2007/0162869 A1
(43) Pub. Date: Jul. 12, 2007

(54) Ultrasonic diagnosis system

(75) Inventors: Yoshinobu Watanabe, Kanagawa (JP); Yoshinao Tannaka, Kanagawa (JP); Takao Suzuki, Kanagawa (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi (JP)

(21) Appl. No.: 10/586,955

(22) PCT Filed: Aug. 25, 2005
(86) PCT No.: PCT/JP05/15435

§ 371 Date: Jul. 25, 2006

(51) Int. Cl. G01N 23/00

(52) U.S. Cl. 715/808; 600/410; 378/1

(57) ABSTRACT

An ultrasonic detecting portion 1 that transmits an ultrasonic wave to a subject and receives a reflected wave therefrom, an image display portion 6 that has a diagnostic image display region 8 for displaying a diagnostic image based on an image signal from the ultrasonic detecting portion and displays a setting button 9 and a cursor 7 of a pointing device for making a selection of a setting condition, and a control portion 5 that has a function of setting and changing the setting condition based on an instruction to select the setting condition are provided. A function in which a pop-up menu opens by locating the cursor on the operation button, and a function in which an alternative in the pop-up menu is selected by locating the cursor on the alternative and the alternative that is selected last is confirmed by moving the cursor to a region outside the pop-up menu are provided. It is possible to select a parameter of the operation button solely with a cursor operation of the pointing device.

### TECHNICAL FIELD

The present invention relates to an ultrasonic diagnosis system in which a setting button arranged on a display screen is operated by using a cursor of a pointing device.

### BACKGROUND ART

As ultrasonic diagnosis apparatuses for detecting a tomographic image of a subject as a real-time ultrasonic dynamic image are made smaller, they are placed at locations other than an ultrasonography room, for example, bedside in a hospital ward, a private clinic, an in-company healthcare center and the like, and play an important role in medical diagnoses and examinations of various kinds.

In general, at the time of an ultrasonic diagnosis, a dedicated console is used. However, with the reduction in size of the apparatus, an ultrasonic diagnosis system has been suggested in which, without using a dedicated console, an operation button is arranged on a screen, and a cursor operation of a pointing device (such as a mouse, a track ball, a track pad or a touch panel) and a clicking (or confirming) operation are combined, thereby realizing an operation necessary for the diagnosis (for example, see Patent document 1 ). However, when changing a parameter of a setting condition, such a system is less operable than a dedicated console because it requires a plurality of setting actions or re-holding with fingertips. In order to improve its operability, a scroll controlling method using a touch pad also has been suggested (for example, see Patent document 2 ).
Patent document 1: JP 11 (1999 )-508461 A
Patent document 2: JP 2000-181617 A

### DISCLOSURE OF INVENTION

### Problem to be Solved by the Invention

In an ultrasonic diagnosis system in which an operation button as a substitute for the console is shown on the screen, it generally is necessary for confirming a certain operation to locate a cursor of a pointing device at the operation button and then perform a clicking operation. This operation is more complicated than in the case where the operation can be confirmed only with a single action using the dedicated console, thus putting a medical doctor under increased stress. Furthermore, since an ultrasonic probe often is operated with his/her dominant hand, the operation method that requires, with the other hand, not only locating the cursor of the pointing device at a predetermined position but also clicking it may lower the diagnostic efficiency considerably.

It is an object of the present invention to provide an ultrasonic diagnosis system capable of selecting and confirming a parameter of a setting condition of an operation button solely with a cursor operation of a pointing device.

### Means for Solving Problem

An ultrasonic diagnosis system according to the present invention includes an ultrasonic detecting portion that transmits an ultrasonic wave to a subject and receives a reflected wave therefrom, an image display portion that has a diagnostic image display region for displaying a diagnostic image based on an image signal from the ultrasonic detecting portion and displays a setting button and a cursor of a pointing device for making a selection of a setting condition, and a control portion that has a function of setting the setting condition based on the selection of the setting condition. The ultrasonic diagnosis system has a function in which a pop-up menu opens by locating the cursor on the operation button, and a function in which an alternative in the pop-up menu is selected by locating the cursor on the alternative and the alternative that is selected last is confirmed by moving the cursor to a region outside the pop-up menu.

With this configuration, an operator of the ultrasonic diagnosis system can select and confirm a parameter only by moving the cursor away from the region in a pop-up menu corresponding to the selected parameter. Thus, it is possible to carry out a system setting with a single hand without any clicking operation, thereby improving the diagnostic efficiency.

Also, an ultrasonic diagnosis system according to the present invention includes an ultrasonic detecting portion that transmits an ultrasonic wave to a subject and receives a reflected wave therefrom, an image display portion that has a diagnostic image display region for displaying a diagnostic image based on an image signal from the ultrasonic detecting portion and displays a setting button and a cursor of a pointing device for making a selection of a setting condition, and a control portion that has a function of setting the setting condition based on the selection of the setting condition. The ultrasonic diagnosis system has a function in which a pop-up menu opens by locating the cursor on the operation button, and a function in which an alternative in the pop-up menu is selected by locating the cursor on the alternative and the alternative that is selected last is confirmed by moving the cursor rightward, leftward, horizontally, upward, downward or vertically in the selected alternative in the pop-up menu.

With this configuration, an operator of the ultrasonic diagnosis system can select a parameter only by moving the cursor away from the region in a pop-up menu corresponding to the selected parameter and confirm an alternative only by moving the cursor within the range of the alternative. Thus, it is possible to carry out a system setting with a single hand without any clicking operation, thereby improving a diagnostic efficiency.

Further, an ultrasonic diagnosis system according to the present invention includes an ultrasonic detecting portion that transmits an ultrasonic wave to a subject and receives a reflected wave therefrom, an image display portion that has a diagnostic image display region for displaying a diagnostic image based on an image signal from the ultrasonic detecting portion and displays a setting button and a cursor of a pointing device for making a selection of a setting condition, and a control portion that has a function of setting the setting condition based on the selection of the setting condition. The ultrasonic diagnosis system has a function in which a pop-up menu opens by locating the cursor on the operation button, and a function in which an alternative in the pop-up menu is selected by locating the cursor on the alternative and the alternative that is selected last is confirmed by keeping the cursor in the selected alternative for a certain period of time.

With this configuration, an operator of the ultrasonic diagnosis system can select a parameter only by moving the cursor away from the region in a pop-up menu corresponding to the selected parameter and confirm an alternative only by stopping the cursor within the range of the alternative. Thus, it is possible to carry out a system setting with a single hand without any clicking operation, thereby improving a diagnostic efficiency.

Moreover, it also may be possible to provide a configuration having a function of setting a time period until the pop-up menu opens by locating the cursor of the pointing device on the operation button drawn on a screen.

With this configuration, the operator's stress can be reduced.

### Effects of the Invention

In an ultrasonic diagnosis system according to the present invention, an operation button as a substitute for a console is shown on a diagnostic screen. All selections based on the operation button can be made only by moving a cursor of a pointing device on the screen.

Accordingly, even when operating a button on the screen with one hand while holding an ultrasonic probe in contact with a subject with the other hand, it becomes unnecessary to make a selection by moving the operating finger and clicking a button, so that an ultrasonic diagnosis can be carried out without taking his/her eyes off from the screen. This produces an effect of reducing a medical doctor's stress so as to improve the diagnostic efficiency.

### BRIEF DESCRIPTION OF DRAWINGS

FIG. 1 is a block diagram showing a configuration of an ultrasonic diagnosis system according to Embodiment 1 of the present invention.

FIG. 2 shows setting buttons on a display screen in Embodiment 1 of the present invention.

FIG. 3A shows an individual operation for a setting button in Embodiment 1 of the present invention.

FIG. 3B shows an operation subsequent to that of FIG. 3A.

FIG. 3C shows an operation subsequent to that of FIG. 3B.

FIG. 3D shows an operation subsequent to that of FIG. 3C.

FIG. 3E shows an operation subsequent to that of FIG. 3D.

FIG. 3F shows an operation subsequent to that of FIG. 3E.

FIG. 4A shows an individual operation for a setting button in an ultrasonic diagnosis system according to Embodiment 2 of the present invention.

FIG. 4B shows an operation subsequent to that of FIG. 4A.

FIG. 4C shows an operation subsequent to that of FIG. 4B.

FIG. 4D shows an operation subsequent to that of FIG. 4C.

FIG. 4E shows an operation subsequent to that of FIG. 4D.

FIG. 4F shows an operation subsequent to that of FIG. 4E.

FIG. 5A shows an individual operation for a setting button in an ultrasonic diagnosis system according to Embodiment 3 of the present invention.

FIG. 5B shows an operation subsequent to that of FIG. 5A.

FIG. 5C shows an operation subsequent to that of FIG. 5B.

FIG. 5D shows an operation subsequent to that of FIG. 5C.

FIG. 5E shows an operation subsequent to that of FIG. 5D.

FIG. 5F shows an operation subsequent to that of FIG. 5E.

### EXPLANATION OF LETTERS OR NUMERALS

| | |
|---|---|
| 1 | Ultrasonic probe |
| 2 | Ultrasonic transmission portion |
| 3 | Ultrasonic reception portion |
| 4 | Filtering portion |
| 5 | Personal computer |
| 6 | Display screen |
| 7 | Cursor |
| 8 | Diagnostic image display region |
| 9 | Setting button |
| 10 | Freeze button |
| 11 | Pop-up menu |

### DESCRIPTION OF THE INVENTION

As embodiments of the present invention, the case of using a personal computer for a control portion will be described, with reference to the accompanying drawings.

### Embodiment 1

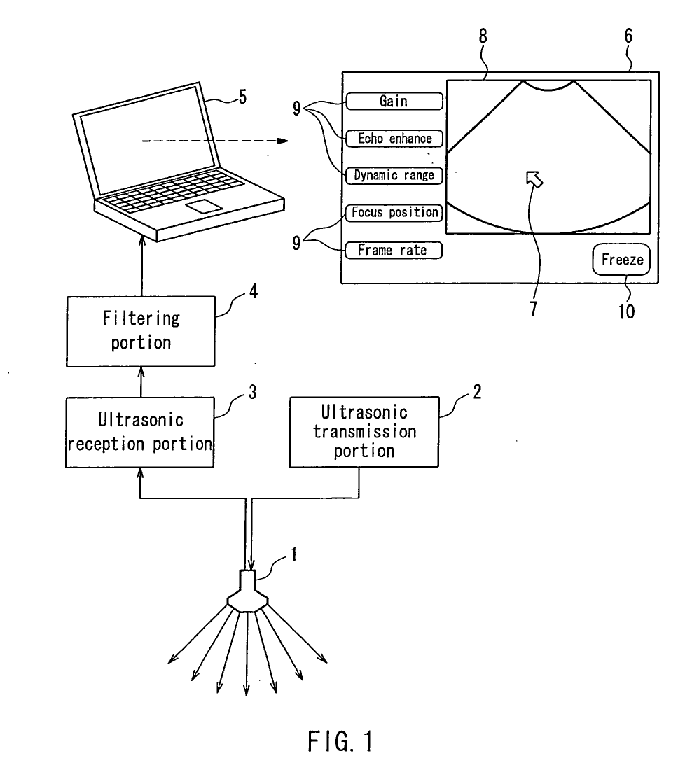

FIG. 1 is a block diagram showing an ultrasonic diagnosis system according to Embodiment 1 of the present invention. In FIG. 1, an ultrasonic transmission portion 2 includes a transmission circuit for an ultrasonic wave and transmits a transmission signal for an ultrasonic wave to an ultrasonic probe 1. The ultrasonic probe 1 transmits an ultrasonic wave to a subject based on the received signal, receives a reflected wave from the subject, converts it into an electric signal and transmits it to an ultrasonic reception portion 3. The signal received by the ultrasonic reception portion 3 is transmitted via a filtering portion 4 for performing various kinds of signal processing to a personal computer 5.

The personal computer 5 displays a diagnostic image display region 8 for displaying an ultrasonic image generated from the received signal, setting buttons 9 for selecting a setting condition, a freeze button 10 for performing a freeze operation and a cursor 7 of a pointing device for an instruction to maintain or change an existing setting condition parameter on a display screen 6 of the personal computer 5. Also, the personal computer 5 controls the selection and confirmation of the setting buttons 9 and the position of the cursor 7, etc. Since this ultrasonic diagnosis system has no dedicated console, the transmission of the ultrasonic wave is controlled and the setting of various diagnostic modes is changed by operating the setting buttons 9 on the display screen 6 using the cursor 7. Items to be set by the setting buttons 9 can include, for example, a gain of an image displayed in the diagnostic image display region 8, the presence or absence of echo enhance, a dynamic range, and a focus position and a frame rate for scanning.

The ultrasonic probe 1 constitutes an ultrasonic detecting portion, and the display screen 6 of the personal computer 5 constitutes an image display portion.

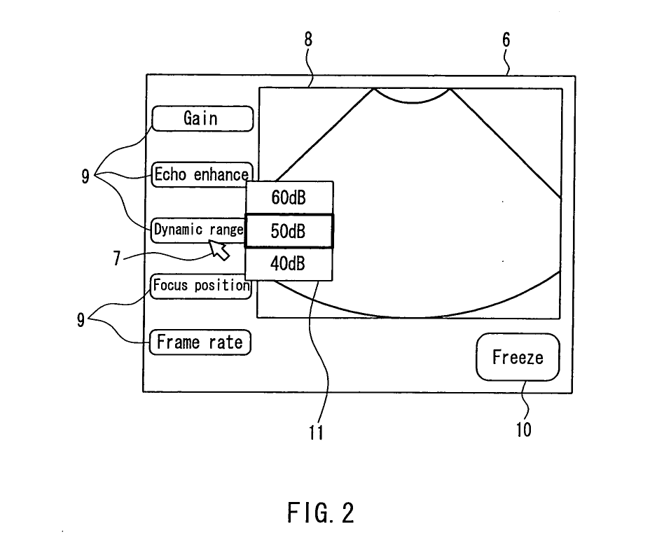

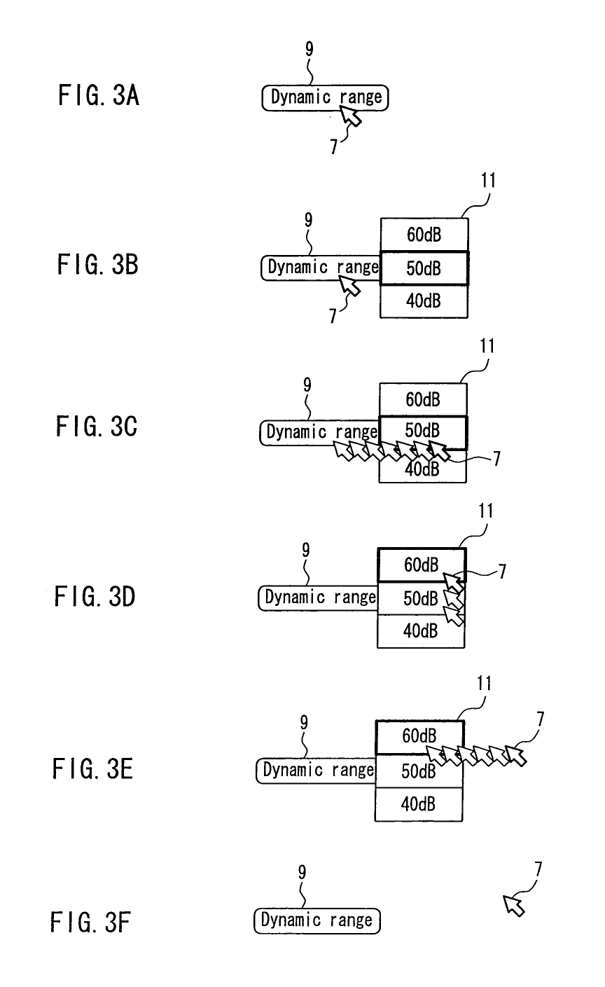

The following is a description of an operation of the ultrasonic diagnosis system with the above-described configuration, with reference to FIGS. 2 and 3A to 3F. FIG. 2 shows the setting buttons on the display screen. FIG. 3 shows an individual operation for a setting button. An operation of setting and changing a parameter by the setting button 9 will be described using the setting button of the dynamic range as an example. For changing a currently set value, the cursor 7 is moved onto the setting button 9 as shown in FIG. 2, whereby a pop-up menu 11 appears automatically, and a process for changing the setting starts. As an example, the pop-up menu 11 includes three alternatives of 60 dB, 50 dB and 40 dB as the parameters of the dynamic range.

This operation corresponds to FIGS. 3A and 3B. When the cursor 7 is moved onto the setting button 9 as shown in FIG. 3A, the alternatives of the setting button 9 are displayed by the pop-up menu 11 as shown in FIG. 3B. The bold line surrounding the alternative 50 dB in FIG. 3B indicates that the current dynamic range is set to 50 dB.

Next, as shown in FIG. 3C, the cursor 7 is moved into the pop-up menu 11. A plurality of the cursors 7 in thin lines displayed here indicate that the cursor 7 is moving, and the cursor 7 eventually reaches the cursor 7 in thick line. When the cursor 7 moves into the range of the alternative 60 dB as shown in FIG. 3D, the alternative 60 dB is selected. The cursor 7 moves from the range of the alternative 60 dB to an outside of the range of the pop-up menu 11 as shown in FIG. 3E, whereby the selection of the alternative 60 dB is confirmed. Finally, in a state shown in FIG. 3F, the setting is completed, and the pop-up menu 11 disappears.

With the above-described ultrasonic diagnosis system according to Embodiment 1 of the present invention, by locating the cursor 7 on the operation button drawn on the screen, selecting an alternative from the opened pop-up menu 11 and moving the cursor 7 from that alternative to the outside of the menu, this alternative is confirmed. In other words, it is possible to select and confirm a parameter of a setting condition corresponding to the setting button only by a cursor operation of a pointing device without the need for any clicking operation, thereby improving the operability and diagnostic efficiency.

### Embodiment 2

The configuration of an ultrasonic diagnosis system according to Embodiment 2 of the present invention is similar to that according to Embodiment 1 except for the operation of confirming various kinds of parameters.

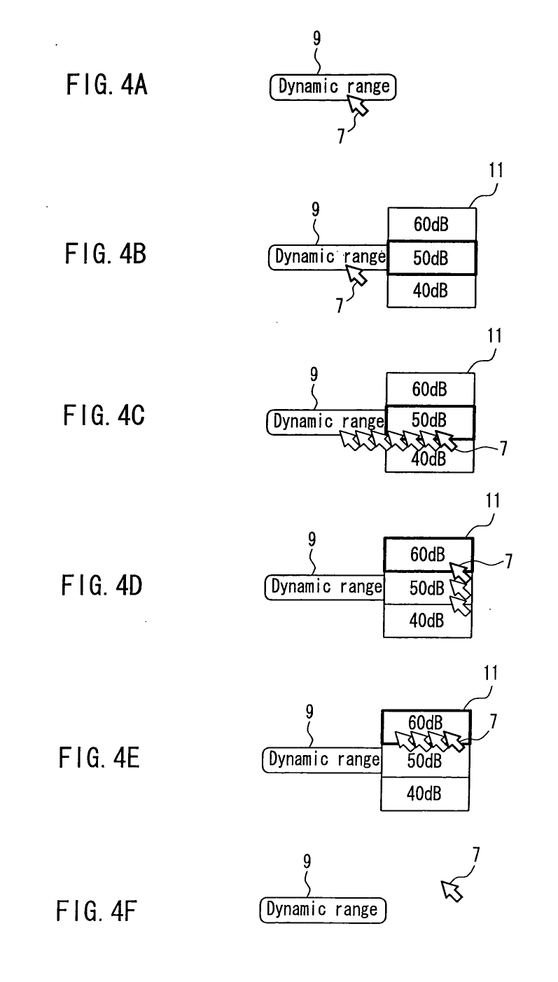

The operation of the ultrasonic diagnosis system will be described, with reference to FIGS. 4A to 4F. FIGS. 4A to 4F show an individual operation for a setting button in the present embodiment. For changing a currently set value using the setting button 9, the cursor 7 first is moved onto the setting button 9 as shown in FIG. 4A Thus, the alternatives including the currently set value are displayed by the pop-up menu 11 as shown in FIG. 4B. The bold line surrounding the alternative 50 dB in FIG. 4B indicates that the current dynamic range is set to 50 dB. As shown in FIG. 4C, the cursor 7 is moved into the pop-up menu 11.

Next, when the cursor 7 moves into the range of the alternative 60 dB as shown in FIG. 4D, the alternative 60 dB is selected. The cursor 7 is swayed rightward or leftward within the range of the alternative 60 dB as shown in FIG. 4E, whereby the selection of the alternative 60 dB is confirmed. Finally, in a state shown in FIG. 4F, the change in setting is completed, and the pop-up menu 11 disappears.

With the above-described ultrasonic diagnosis system according to Embodiment 2, by locating the cursor 7 of the pointing device on the operation button drawn on the screen, selecting an alternative from the automatically opened menu and swaying the cursor 7 rightward or leftward over this alternative, the parameter value that is selected last is confirmed. In other words, it is possible to conduct the operation without the need for any clicking operation.

It should be noted that the operation of confirming the alternative also may be swaying of the cursor 7 horizontally, upward, downward or vertically within the range of that alternative.

### Embodiment 3

The configuration of an ultrasonic diagnosis system according to Embodiment 3 of the present invention is similar to that according to Embodiment 1 except for the operation of confirming various kinds of parameters.

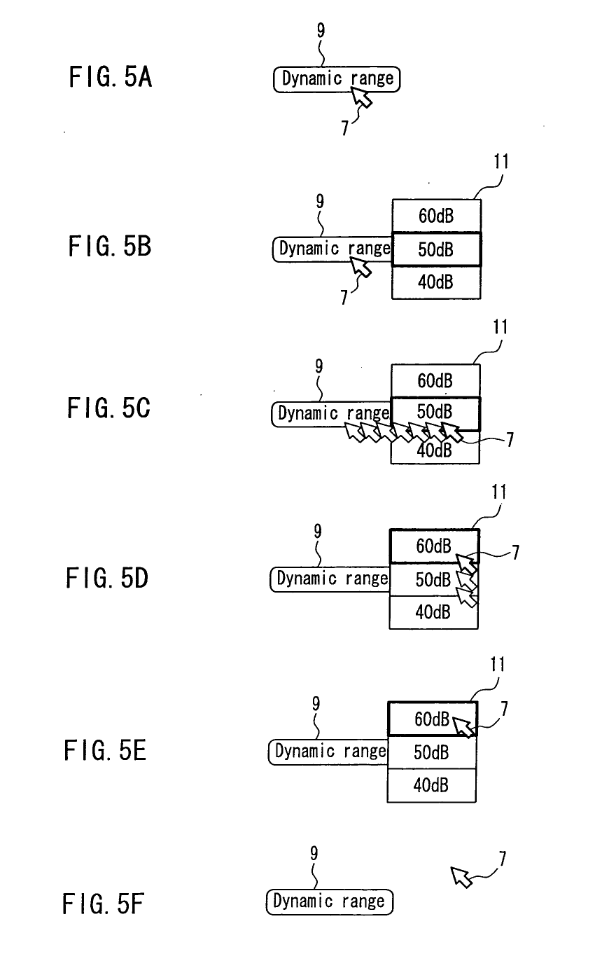

The operation of the ultrasonic diagnosis system in the present embodiment will be described, with reference to FIGS. 5A to 5F. FIGS. 5A to 5F show an individual operation for a setting button in the present embodiment. For example, for changing a currently set value using the setting button 9, the cursor 7 is moved onto the setting button 9 as shown in FIG. 5A. Next, the alternatives including the currently set value are displayed by the pop-up menu 11 as shown in FIG. 5B. The bold line surrounding the alternative 50 dB in FIG. 5B indicates that the current dynamic range is set to 50 dB.

Next, as shown in FIG. 5C, the cursor 7 is moved into the pop-up menu 11. When the cursor 7 is moved into the range of the alternative 60 dB as shown in FIG. 5D, the alternative 60 dB is selected. Further, as shown in FIG. 5E, the cursor 7 is stopped for a certain period of time (for example, 1 second) within the range of the alternative 60 dB in the pop-up menu 11, whereby the selection of the alternative 60 dB is confirmed. After the act of stopping the cursor 7 is recognized as the confirming operation, the setting is completed, and the pop-up menu 11 disappears in a state shown in FIG. 5F.

With the above-described ultrasonic diagnosis system according to Embodiment 3 of the present invention, by locating the cursor 7 on the operation button drawn on the screen, selecting an alternative from the automatically opened pop-up menu and keeping the cursor 7 over this alternative for a specific period, the parameter value that is selected last is confirmed. In other words, it is possible to conduct the operation without the need for any clicking operation.

Incidentally, in the ultrasonic diagnosis systems according to Embodiments 1 to 3, by conducting the operation of confirming the selection (i.e., moving the cursor away from the region of the alternative, moving the cursor horizontally within the alternative, stopping the cursor within the alternative for a certain period of time, or the like) in the pop-up menu showing a currently set value, it is possible to maintain the currently set value without changing the condition.

Also, after moving the cursor 7 into the pop-up menu 11 and selecting a setting of the condition and immediately before confirming the setting, the cursor 7 may be moved to the position of the setting button 9 and then moved from this position to regions other than the setting button 9 and the pop-up menu 11, thereby allowing the setting and changing operation to be canceled.

Moreover, in the present invention, the alternatives do not have to be displayed as the pop-up menu. Any form may be appropriate as long as alternatives having a region that can be selected and confirmed with a cursor can be displayed.

Further, although the above description has illustrated an example of configuring the control portion of the ultrasonic diagnosis system with the personal computer, other dedicated control portions also can be used in a similar manner. Likewise, although an example of the configuration of the ultrasonic diagnosis system having no dedicated console has been described, a system having other dedicated consoles can use the above-described configuration in combination in a similar manner. Furthermore, although an example of the configuration using a single ultrasonic diagnosis system has been described, the case of using the above-described configuration for a display apparatus on the side of conducting remote control via a network or the like can be carried out in a similar manner.

In addition, it also may be possible to provide a function of setting a time period until the pop-up menu opens by locating the cursor of the pointing device on the operation button drawn on the screen.

### INDUSTRIAL APPLICABILITY

The present invention is an ultrasonic diagnosis system in which an operation button, etc. as a substitute for a console is drawn on a diagnostic screen and allows a user to operate a button on the screen with one hand while holding an ultrasonic probe in contact with a subject with the other hand. Accordingly, the present invention makes it possible to carry out an ultrasonic diagnosis without taking his/her eyes off from the screen, and is useful as an ultrasonic diagnosis system achieving an effect of reducing a medical doctor's stress so as to improve a diagnostic efficiency.

1. An ultrasonic diagnosis system comprising:
an ultrasonic detecting portion that transmits an ultrasonic wave to a subject and receives a reflected wave therefrom;
an image display portion that has a diagnostic image display region for displaying a diagnostic image based on an image signal from the ultrasonic detecting portion and displays a setting button and a cursor of a pointing device for making a selection of a setting condition; and
a control portion that has a function of setting the setting condition based on the selection of the setting condition;
wherein the ultrasonic diagnosis system has
a function in which a pop-up menu opens by locating the cursor on the setting button, and
a function in which an alternative in the pop-up menu is selected by locating the cursor on the alternative and the alternative that is selected last is confirmed by moving the cursor to a region outside the pop-up menu.

2-4. (canceled)

5. The ultrasonic diagnosis system according to claim 1, which has a function of setting a time period until the pop-up menu opens by locating the cursor of the pointing device on the setting button drawn on a screen.

6. An ultrasonic diagnosis system comprising:
an ultrasonic detecting portion that transmits an ultrasonic wave to a subject and receives a reflected wave therefrom;
an image display portion that has a diagnostic image display region for displaying a diagnostic image based on an image signal from the ultrasonic detecting portion and displays a setting button and a cursor of a pointing device for making a selection of a setting condition; and
a control portion that has a function of setting the setting condition based on the selection of the setting condition;
wherein the ultrasonic diagnosis system has
a function in which a pop-up menu opens by locating the cursor on the setting button, and
a function in which an alternative in the pop-up menu is selected by locating the cursor on the alternative and the alternative that is selected last is confirmed by moving the cursor rightward, leftward, horizontally, upward, downward or vertically in the selected alternative in the pop-up menu.

7. The ultrasonic diagnosis system according to claim 6, which has a function of setting a time period until the pop-up menu opens by locating the cursor of the pointing device on the operation button drawn on a screen.

8. An ultrasonic diagnosis system comprising:
an ultrasonic detecting portion that transmits an ultrasonic wave to a subject and receives a reflected wave therefrom;
an image display portion that has a diagnostic image display region for displaying a diagnostic image based on an image signal from the ultrasonic detecting portion and displays a setting button and a cursor of a pointing device for making a selection of a setting condition; and
a control portion that has a function of setting the setting condition based on the selection of the setting condition;
wherein the ultrasonic diagnosis system has
a function in which a pop-up menu opens by locating the cursor on the setting button, and
a function in which an alternative in the pop-up menu is selected by locating the cursor on the alternative and the alternative that is selected last is confirmed by keeping the cursor in the selected alternative for a certain period of time.

9. The ultrasonic diagnosis system according to claim 8, which has a function of setting a time period until the pop-up menu opens by locating the cursor of the pointing device on the setting button drawn on a screen.
